(19) United States
(12) Patent Application Publication
(10) Pub. No.: US 2006/0010194 A1
(43) Pub. Date: Jan. 12, 2006

(54) Document data managing apparatus, document data management method, and computer product

(75) Inventor: Yoshiyuki Inage, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/019,219

(22) Filed: Dec. 23, 2004

(30) Foreign Application Priority Data
Jul. 6, 2004 (JP) 2004-199362

(51) Int. Cl. G06F 15/16

(52) U.S. Cl. 709/201

(57) ABSTRACT

Information relating to a website that is to be deleted is received. The information received is disclosed and comments are collected on the information disclosed. It is determined whether to delete the website based on number of comment collected and number of viewers who see the disclosed information.

### BACKGROUND OF THE INVENTION

1) Field of the Invention

The present invention relates to a technology for deleting websites.

2) Description of the Related Art

With the popularization of the Internet in recent years, a great number of web servers have been set up to provide web services that enable clients to view websites. A website includes at least one document data. For example, Japanese Patent Application Laid-open No. 2001-243145 discloses a website construction supporting apparatus that can easily construct a website for distributing live images. There are also activities aimed at supporting improvements in website-creating technology, such as various website contests in which competitors compete in creating superior websites.

However, no matter how good the websites are, the value of the information they provide decreases as time passes, resulting in many unwanted websites. The website creator must decide whether a website is unwanted, and, if so, delete it.

Unlike when creating websites, there is no motivation to delete them, leading to a problem that unwanted websites are left undeleted. In particular, unwanted websites result in wasteful use of disks.

### SUMMARY OF THE INVENTION

It is an object of the present invention to provide a technology to easily delete a website.

A document data managing apparatus according to an aspect of the present invention includes a deletion information receiving unit that receives deletion document data information, being information relating to document data to be deleted, from document data managers; a deletion information disclosing unit that discloses the deletion document data information received and collects evaluation information relating to the document data; and a deletion determining unit that determines whether to delete the document data based on the evaluation information collected, and, when determined to delete, deletes the document data.

A document data management method apparatus according to another aspect of the present invention includes receiving deletion document data information, being information relating to document data to be deleted, from document data managers; disclosing the deletion document data information received at the receiving; collecting evaluation information relating to the deletion document data information disclosed at the disclosing; determining whether to delete the document data based on the evaluation information collected at the collecting; and deleting the document data when it is determined at the determining to delete the deletion data.

A computer-readable recording medium according to still another aspect of the present invention stores therein a computer program that causes a computer to execute the above method according to the present invention.

The other objects, features, and advantages of the present invention are specifically set forth in or will become apparent from the following detailed description of the invention when read in conjunction with, the accompanying drawings.

### BRIEF DESCRIPTION OF THE DRAWINGS

FIG. 1 is a functional block diagram of a web service system according to a first embodiment of the present invention;

FIG. 2 is an example of a portal site screen that solicits websites to be deleted (hereinafter, “deletion websites”);

FIG. 3 is an example of a screen for soliciting deletion websites (hereinafter, “website deletion soliciting screen”);

FIG. 4 is an example of a screen for registering deletion websites (hereinafter, “deletion website registration screen”);

FIG. 5 is an example of an e-mail notifying the start of URL posting;

FIG. 6 is an example of the data structure of deletion URL information, which a deletion URL information storage unit stores in correspondence with each deletion website;

FIG. 7 is an example of a screen that displays a deletion website;

FIG. 8 is an example of a comment write screen;

FIG. 9 is an example of an e-mail notifying that a comment has been written;

FIG. 10 is an example of an e-mail notifying the end of URL posting;

FIG. 11 is a flowchart of a website deletion processing executed by the web service system shown in FIG. 1;

FIG. 12 is a flowchart of a URL reception processing executed by a deletion URL collection unit shown in FIG. 1;

FIG. 13 is a flowchart of a process procedure to determine whether a deletion URL is valid;

FIG. 14 is a flowchart of a process procedure to determine whether there is a problem in a website;

FIG. 15 is a flowchart of a comment reception processing executed by a deletion URL disclosure unit shown in FIG. 1;

FIG. 16 is a flowchart of a process procedure to determine whether there is a problem in a comment;

FIG. 17 is a flowchart of a website deletion determination processing executed by a deletion determining unit shown in FIG. 1;

FIG. 18 is a flowchart of a process procedure to determine whether to delete a website;

FIG. 19 is a functional block diagram of a web service system according to a second embodiment of the present invention;

FIG. 20 is a flowchart of a process procedure performed by a deletion-consideration request unit shown in FIG. 19;

FIG. 21 is a diagram of a computer system that executes a computer program according to the first and the second embodiments; and

FIG. 22 is a functional block diagram of a main unit shown in FIG. 21.

### DETAILED DESCRIPTION

Exemplary embodiments of a document data managing apparatus, a document data management method, and a computer product according to the present invention will be explained in detail with reference to the accompanying drawings.

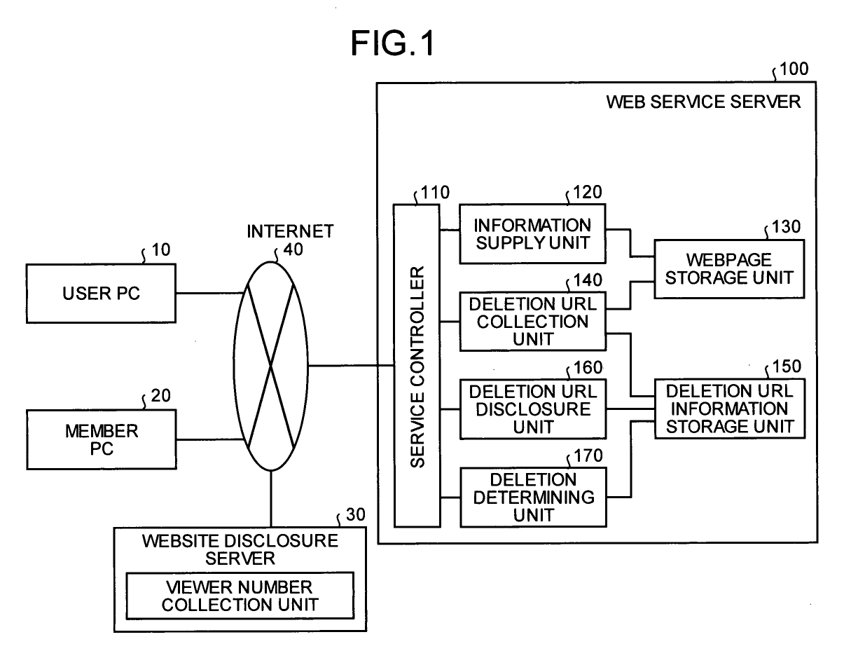

FIG. 1 is a functional block diagram of a web service system according to a first embodiment of the present invention.

The web serve system includes a user personal computer (PC) 10, a member PC 20, a website disclosure server 30, and a web service server 100, these being connected to the Internet 40.

The user PC 10 is a personal computer used by a user who publicly discloses a website, and the website disclosure server 30 is a server that is used in publicly disclosing the website of the user.

The member PC 20 is a personal computer used by members of a members-only organization that provides Internet services. The members are recruited by an Internet service provider or the like. The members-only organization operates a members-only website that provides services to its members. The members access the website to receive its services.

While this explanation describes only one user PC 10, the member PC 20, and the website disclosure server 30 for sake of convenience, the web service system actually includes a great number of user PCs, member PCs, and website disclosure servers.

The web service server 100 is a server that functions as a members-only site, supplying a variety of information to members and offering a service for deleting websites that are disclosed by the website disclosure server 30.

Specifically, the web service server 100 solicits “deletion websites” on its members-only website, discloses information relating to the deletion websites during a fixed period of time, specified by users who responded, and accepts comments regarding the deletion websites from users.

When the disclosure period ends, the web service server 100 determines whether to delete a website based on comments regarding the deletion website and the number of viewers who viewed it, and, when deleting, requests deletion by the website disclosure server 30.

The web service server 100 includes a service controller 110, an information supply unit 120, a website storage unit 130, a deletion URL collection unit 140, a deletion URL information storage unit 150, a deletion URL disclosure unit 160, and a deletion determining unit 170.

The service controller 110 is a processor that transmits communications between the user PC 10, the member PC 20, the website disclosure server 30, and the Internet 40, and in addition, controls all the services supplied by the web service server 100.

The information supply unit 120 is a processor that supplies information in response to requests from the user PC 10 and the member PC 20. Specifically, the information supply unit 120 receives a URL via the service controller 110, and supplies information specified in the URL.

The website storage unit 130 is a storage unit that stores information supplied by the web service server 100. The information supply unit 120 supplies the information after reading it from the website storage unit 130.

The deletion URL collection unit 140 is a processor that collects information relating to deletion websites among the websites disclosed on the website disclosure server 30. Specifically, the deletion URL collection unit 140 solicits deletion websites on a members-only portal site, receives information relating to the deletion websites from users who responded, and stores the information in the deletion URL information storage unit 150.

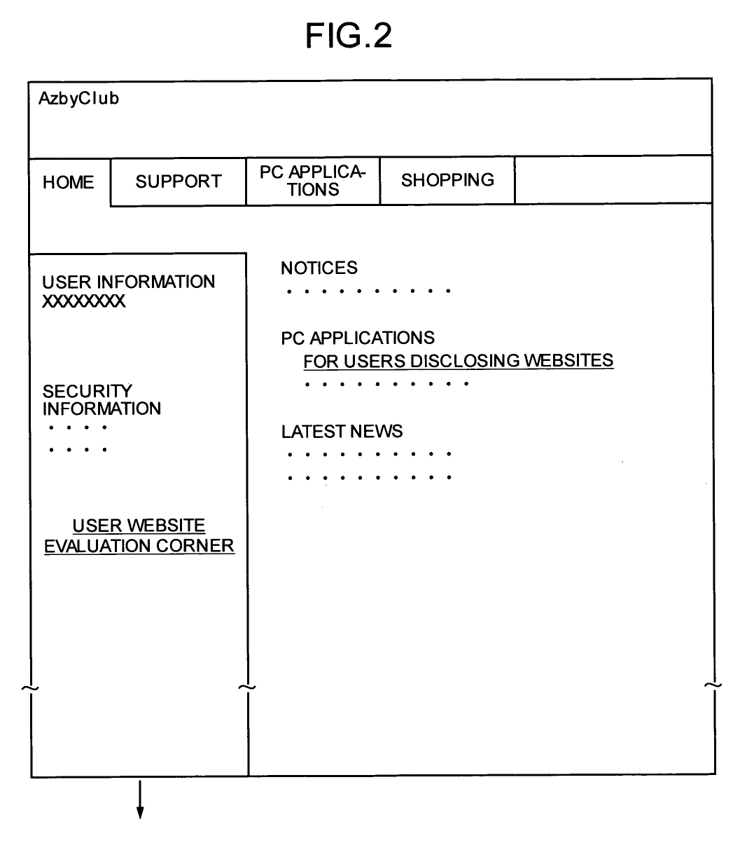

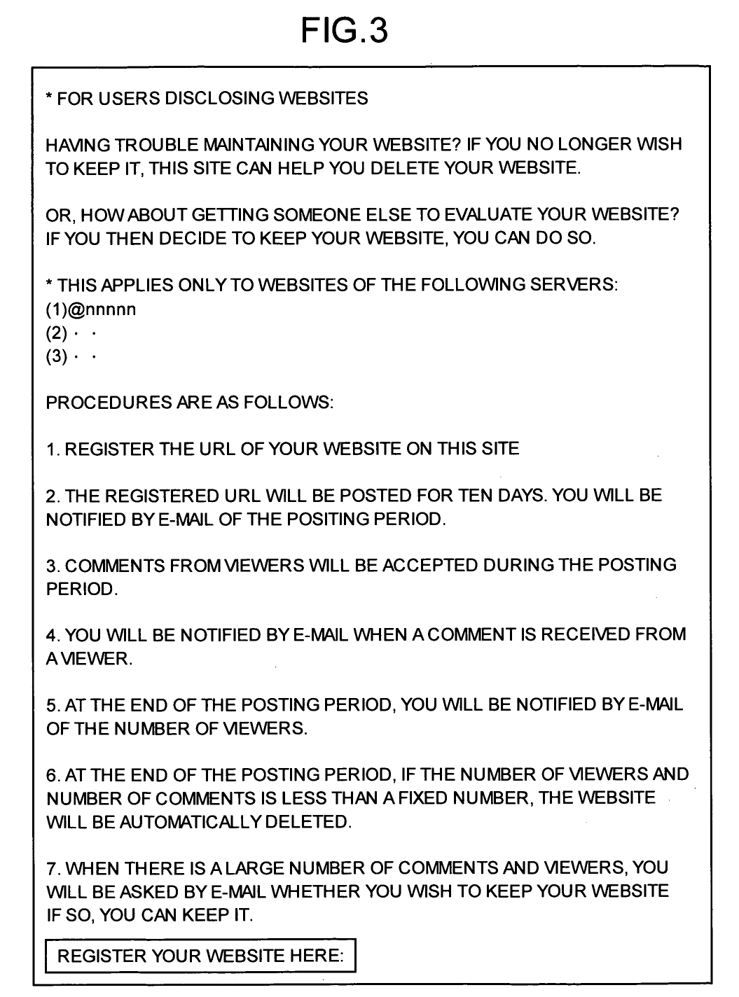

FIG. 2 is an example of a members-only portal site screen that solicits deletion websites. As shown in FIG. 2, when the user clicks on the box “For users disclosing websites”, the website deletion soliciting screen of FIG. 3 is displayed.

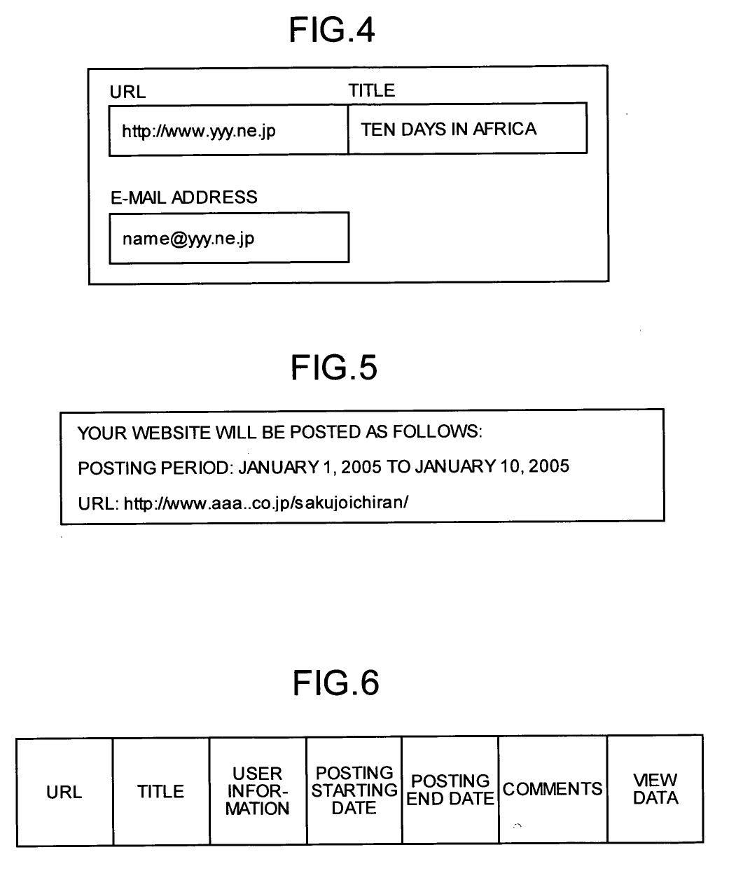

When a user who wishes to delete a website selects “To register a website”, the deletion website registration screen of FIG. 4 is displayed. The user uses the deletion website registration screen to input information relating to the deletion website, such as its URL, and the deletion URL collection unit 140 stores the information input by the user in the deletion URL information storage unit 150.

At the time of soliciting deletion websites, the deletion URL collection unit 140 changes the content of the members-only portal site, stored in the website storage unit 130, to display the screen of FIG. 2. Accordingly, this makes it possible to widely solicit deletion websites from users and members who access the members-only portal site. At the start of the period during which URLs of the deletion websites are posted, the deletion URL collection unit 140 sends an e-mail such as that shown in FIG. 5 to users, notifying them that the URLs are to be posted.

The deletion URL information storage unit 150 is a storage unit that stores information relating to deletion websites specified by users. FIG. 6 is an example of a data structure of deletion URL information, stored by the deletion URL information storage unit 150 in correspondence with each deletion website.

As shown in FIG. 6, the deletion URL information contains the URL of the deletion website (hereinafter, “deletion URL”), its title, user information of the e-mail address of the user, a starting date and an end date of the period during which the information will be posted as a deletion website, comments regarding the deletion website, and view data of the number of viewers of the deletion website and the number of comment-writers.

The deletion URL disclosure unit 160 is a processor that discloses information relating to the deletion websites, which are collected by the deletion URL collection unit 140, during the fixed period of time, collects comments regarding the deletion websites, and stores them in the deletion URL information storage unit 150.

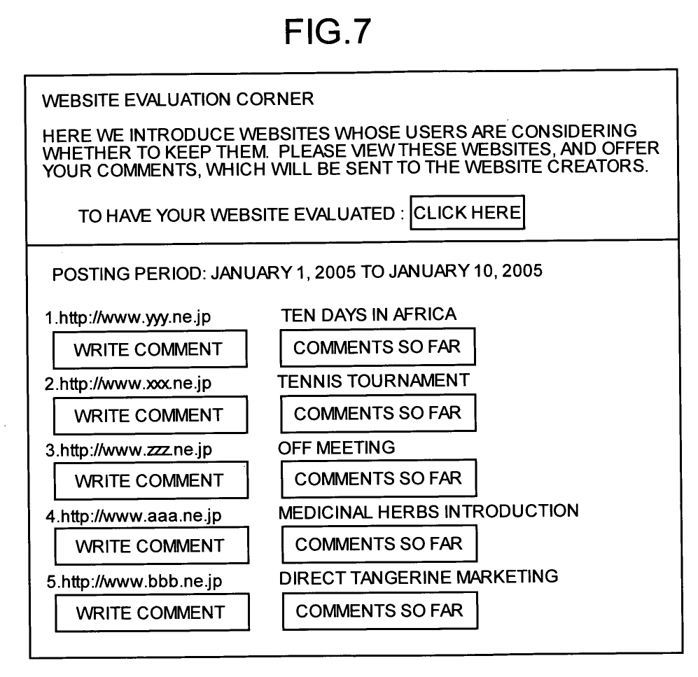

FIG. 7 is an example of a screen that displays a deletion website. As shown in FIG. 7, the deletion URL disclosure unit 160 displays the URL and title of the deletion website, and receives listings of written comments and past comments. The screen that displays the deletion websites is displayed by clicking on the “Evaluation of User Websites” box in the members-only portal site screen of FIG. 2.

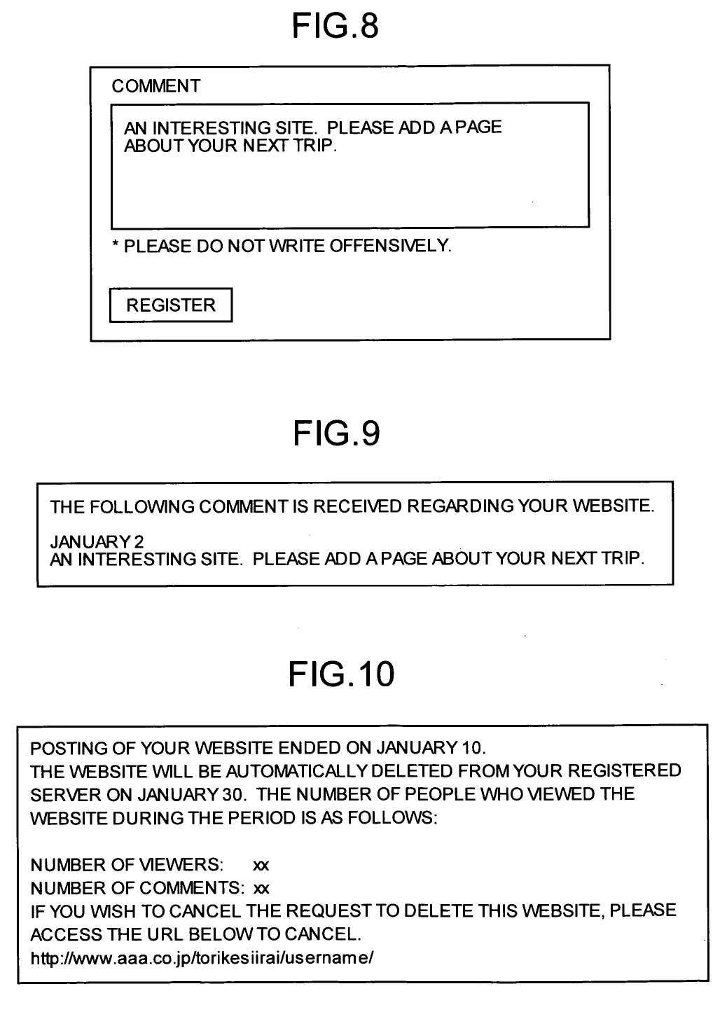

FIG. 8 is an example of a comment write screen. When the “write comment” button is selected in FIG. 7, the deletion URL disclosure unit 160 displays the comment write screen of FIG. 8, and allows comments relating to the deletion website to be written.

Since the deletion URL disclosure unit 160 accepts comments relating to the deletion website, the web service server 100 can determine whether to actually delete the deletion website.

The deletion URL disclosure unit 160 notifies the user who created the deletion website that a comment has been written, by sending him/her the e-mail shown in FIG. 9, and sends the e-mail shown in FIG. 10 when the posting period of the deletion website ends.

The deletion determining unit 170 is a processor that determines whether to actually delete the deletion website based on the comments, collected by the deletion URL disclosure unit 160, and the number of viewers, collected by the website disclosure server 30. When the deletion determining unit 170 determines that a website should be deleted, it requests deletion by the website storage unit 130.

The deletion determining unit 170 determines whether to actually delete the deletion website, and if so, requests deletion by the website storage unit 130, thereby preventing unwanted websites from being left undeleted.

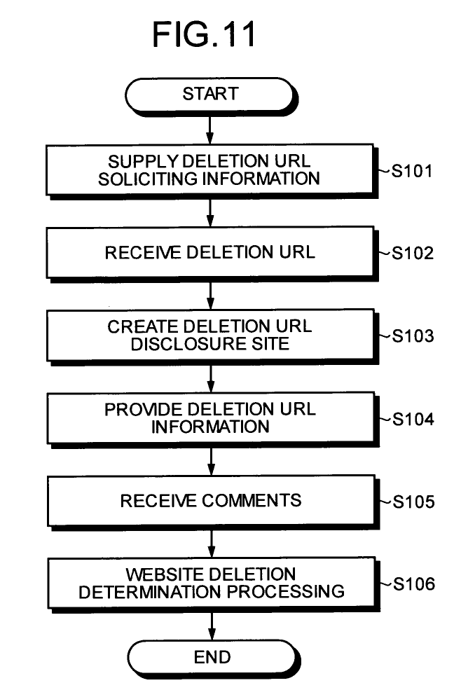

A processing sequence of website deletion processing executed by the web service server 100 according to the first embodiment will be explained. FIG. 11 is a flowchart of the processing sequence of website deletion processing executed by the web service server 100 according to the first embodiment.

As shown in FIG. 11, in the website deletion processing, the deletion URL collection unit 140 supplies deletion URL soliciting information by changing the members-only portal site (step S101), and receives deletion URL from the user who created the website (step S102).

When the period for posting the deletion website starts, the deletion URL disclosure unit 160 creates a deletion URL disclosure site (step S103), and provides regular deletion URL information (step S104). The deletion URL disclosure site can be accessed from the members-only portal site.

Comments regarding the deletion websites are accepted from members and the like (step S105), and, when the deletion website disclosure period ends, the deletion determining unit 170 determines whether to delete the website (step S106)

The deletion determining unit 170 determines whether to actually delete the website based on the comments and the number of viewers, and, when it determines to delete the website, requests deletion by the website disclosure server 30.

Since the deletion determining unit 170 determines whether to delete the website based on the number of viewers of the deletion website and the comments collected by the deletion URL disclosure unit 160, and, when it determines to delete the website, requests deletion by the website disclosure server 30, it is possible to prevent unwanted websites from being left undeleted.

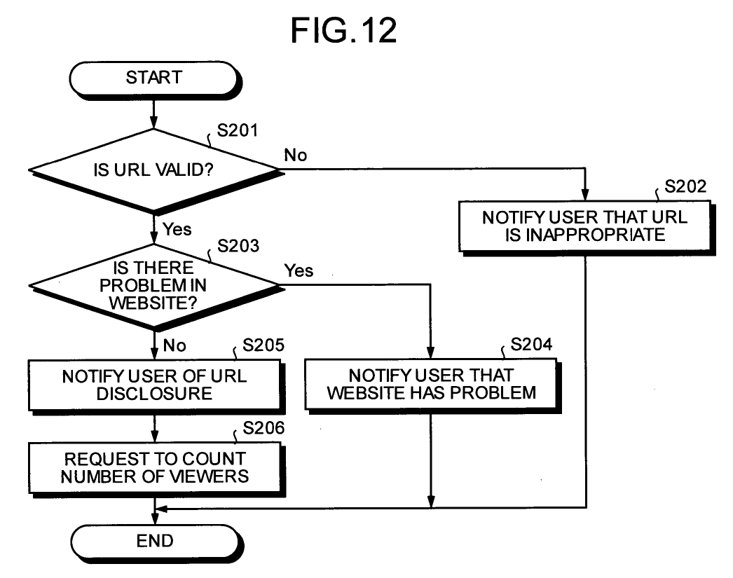

A processing sequence of URL reception processing executed by the deletion URL collection unit 140 will next be explained. FIG. 12 is a flowchart of the processing sequence of URL reception processing executed by the deletion URL collection unit 140. In step S102 of FIG. 11, this URL reception processing is executed for each deletion URL.

As shown in FIG. 12, in the URL reception processing, the deletion URL collection unit 140 determines whether a received URL is valid (step S201). Specifically, it is determined whether the received URL and the server specified by the URL have a contract to supply deletion services via the web service server 100.

When the URL or the server is invalid, the user is notified that the URL is inappropriate and processing ends (step S202). When the URL and the server are valid, it is determined whether there is any problem in the contents of the deletion website (step S203).

When there is a problem in the content of the deletion website, the user is notified of this fact and processing ends (step S204). When there is no problem, the user is notified of URL disclosure by the e-mail shown in FIG. 5 (step S205). A request to count the number of viewers of the deletion website during its posting period is sent to the website disclosure server 30 (step S206).

By making a request to count the number of viewers of the deletion website during the posting period to the website disclosure server 30 in this way, the deletion URL collection unit 140 is able to obtain the number of viewers, which is used in determining whether to delete the website.

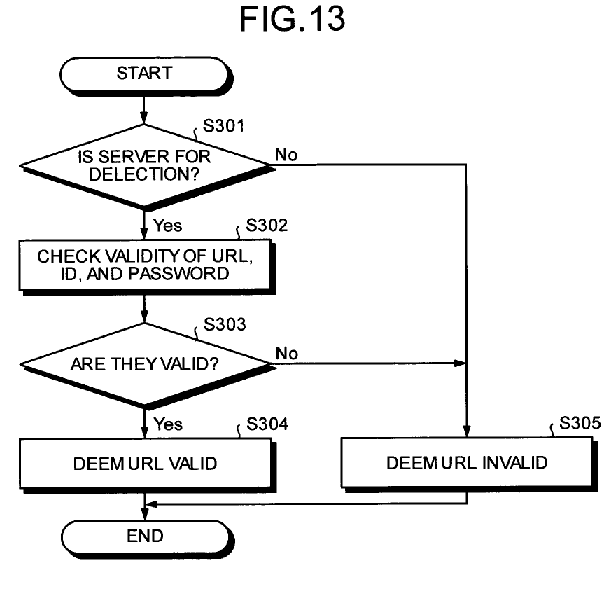

A processing sequence of processing to determine whether a deletion URL is valid will be explained. FIG. 13 is a flowchart of a processing sequence of processing to determine whether a deletion URL is valid. This determination processing corresponds to step S201 of FIG. 12.

As shown in FIG. 13, in this processing, it is determined whether the server specified by the URL is a server for deletion (step S301), and if so, it is determined whether the URL, user ID, and password, which are input by the user, are valid (steps S302 and S303).

When the URL, the ID, and the password are valid, the URL is deemed to be valid (step S304). When any one of the URL, the ID, and the password, is invalid, or when the server is not the one to be deleted, the URL is deemed invalid (step S305).

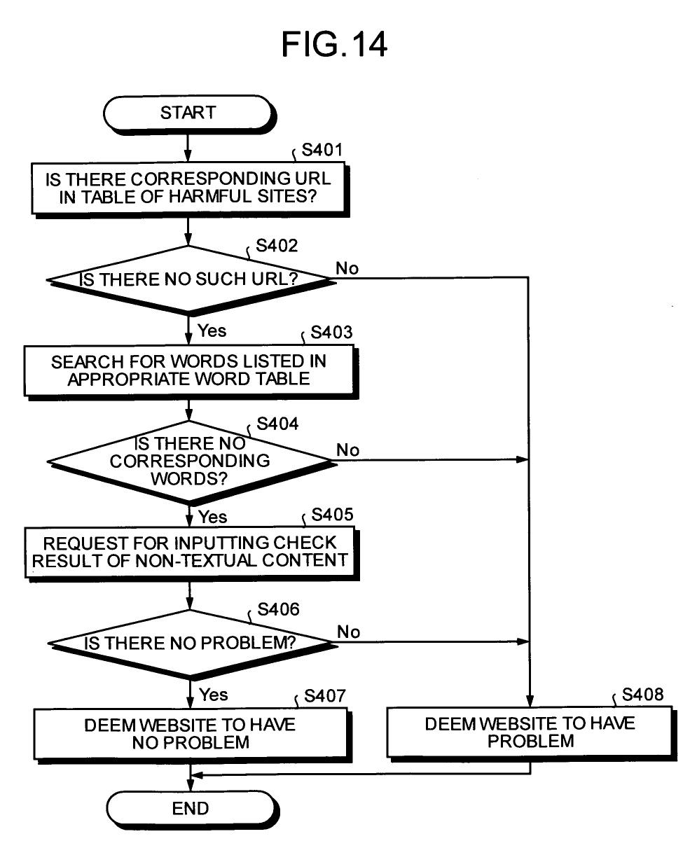

A processing sequence of processing to determine whether there is a problem in the website will be explained. FIG. 14 is a flowchart of the processing sequence of processing to determine whether there is a problem in the website. This determination processing corresponds to step S203 of FIG. 12.

As shown in FIG. 14, in this processing, it is determined whether there is a corresponding URL in a table listing harmful sites (steps S401 and S402), and, when there is no such URL, it is determined whether any inappropriate words, listed in an inappropriate word table (steps S403 and S404) is used on the website.

When no inappropriate words are used on the website, a request is made to the manager of the web service server 100 to check whether there is any inappropriate non-textual content on the website (step S405), and the check result is input.

A determination is made after receiving the check result (step S406), and, where there is no problem, the website is deemed to have no problem (step S407). When the check result indicates a problem, or when it is determined in step S403 that an inappropriate word is used on the website, or when it is determined in step S402 that the website matches a harmful site, the website is deemed to have a problem (step S408).

While, in this example, the manager of the web service server 100 checks whether the website contains any non-textual problems, the check may be carried out by someone else, such as a checking specialist.

The check for non-textual problems in the website may be omitted. The table listing harmful sites and the inappropriate word table may be created from other information, or from independently collected information.

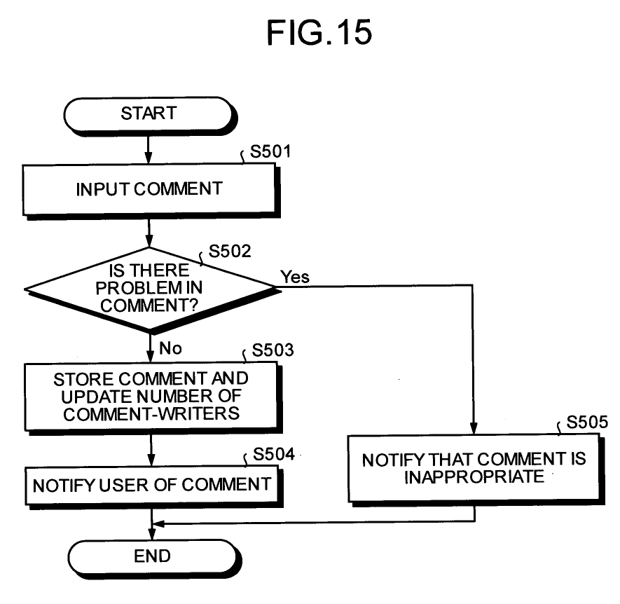

A processing sequence of comment reception processing, executed by the deletion URL disclosure unit 160, will be explained. FIG. 15 is a flowchart of the processing sequence of comment reception processing, executed by the deletion URL disclosure unit 160. The comment reception processing is executed for each comment in step S105 of FIG. 11.

As shown in FIG. 15, in the comment reception processing, comments written by members are input (step S501), and it is determined whether there is a problem in the input comments (step S502).

When there is no problem in a comment, it is stored in the deletion URL information storage unit 150, and the number of comment-writers in the view data is updated (step S503). The user, who created the deletion website that is the object of the written comment, is notified of the comment (step S504). On the other hand, when there is a problem in the comment, the member who wrote it is notified that the comment is inappropriate (step S505).

Since the deletion URL disclosure unit 160 receives comments regarding the deletion website, stores them in the deletion URL information storage unit 150 and updates the number of comment-writers, data for determining whether to actually delete the deletion website can be collected.

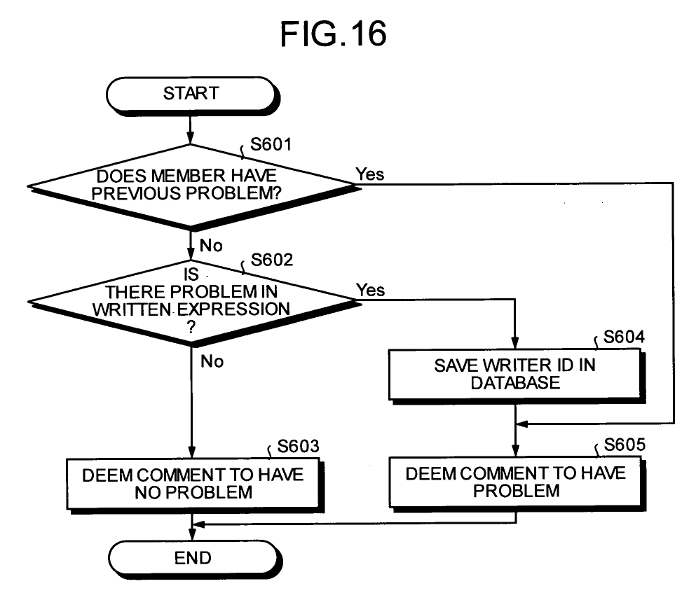

A processing sequence of processing to determine whether a comment has a problem will be explained. FIG. 16 is a flowchart of the processing sequence of processing to determine whether a comment has a problem. This determination processing corresponds to step S502 of FIG. 15.

As shown in FIG. 16, in this determination processing, it is determined whether a member who wrote a comment has previously written a problematic comment, by using the ID input by the member (step S601). When the member who wrote the comment has no problem, it is determined whether there is a problem in the written expression (step S602).

It is determined whether there is a problem in the written expression by determining whether the written expression contains an inappropriate word, listed in the inappropriate word table that is used in determining whether there is a problem in the website.

When there is no problem in the written expression, the comment is deemed to have no problem (step S603), and when there is a problem in the written comment, the ID of the writer is saved in a database (step S604), and the comment is deemed problematic (step S605).

The database that the writer's ID is saved in is used in step S601 to determine whether the member who wrote the comment has previously written a problematic comment. When it is determined in step S601 that the member who wrote the comment has previously written a problematic comment, processing proceeds to step S605 where the comment is deemed problematic.

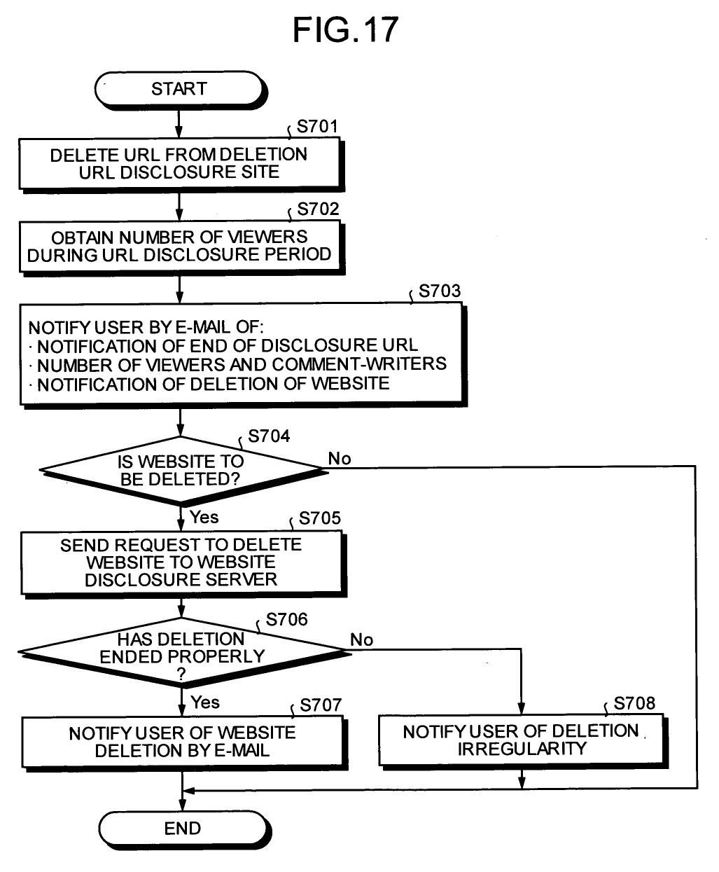

A processing sequence of website deletion determination processing, executed by the deletion determining unit 170, will next be explained. FIG. 17 is a flowchart of the processing sequence of website deletion determination processing, executed by the deletion determining unit 170. The website deletion determination processing is executed for each deletion URL in step S106 of FIG. 11.

As shown in FIG. 17, in the website deletion determination processing, information such as the corresponding URL is deleted from the deletion URL disclosure site (step S701), and the number of viewers during disclosure of the deletion URL is obtained from the website disclosure server 30 and stored as view data in the deletion URL information storage unit 150 (step S702).

The user is then notified of the number of comment-writers and the number of viewers, stored as view data in the deletion URL information storage unit 150, in addition to the end of disclosure of the deletion URL, and a website deletion notification, by transmitting the e-mail shown in FIG. 10 (step S703).

The deletion determining unit 170 determines whether to delete the website based on the number of viewers and the number of comment-writers (step S704). When a determination is made not to delete, processing ends. On the other hand, when a determination is made to delete, a request to delete the website is sent to the website disclosure server 30 (step S705), and it is determined whether deletion has properly ended based on the response to the request from the website disclosure server 30 (step S706).

When deletion has properly ended, the user is notified that the website has been deleted (step S707). When deletion has not ended properly, the user is notified of the irregularity in deleting the website (step S708).

Since the deletion determining unit 170 determines whether to delete the website based on the number of viewers and the number of comment-writers, and, when determined to delete, requests deletion of the website from the website disclosure server 30, it is possible to prevent an unwanted website from being left undeleted.

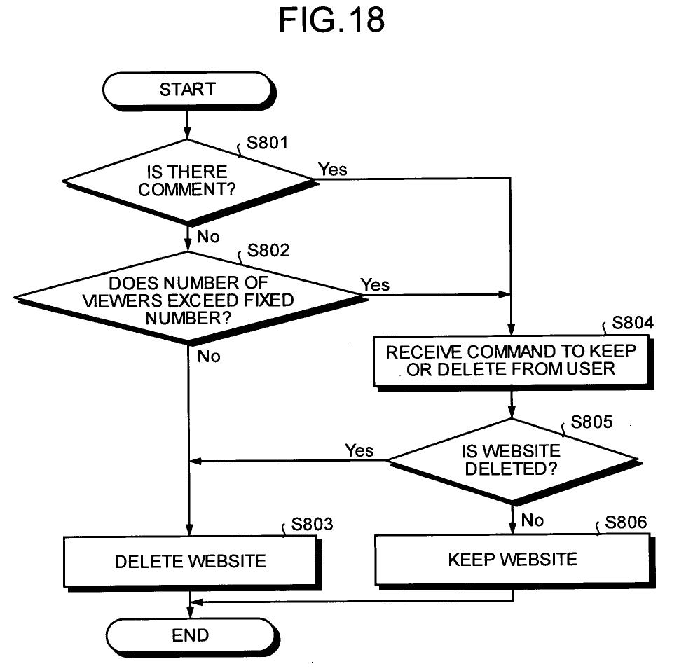

A processing sequence of processing that determines whether to delete a website will be explained. FIG. 18 is a flowchart of the processing sequence of processing that determines whether to delete a website. This determination processing corresponds to the processing of step S704 in FIG. 17.

As shown in FIG. 18, in this determination processing, it is determined from the number of comment-writers whether there is a comment (step S801), and, when there is no comment, it is determined whether the number of viewers exceeds a fixed number (step S802).

When the number of viewers does not exceed the fixed number, it is determined to delete the website (step S803). When the number of viewers exceeds the fixed number, or when it is determined in step S801 that there is a comment, a command to delete or keep is received from the user (step S804). Specifically, an e-mail, requesting that the user inputs a command to delete or keep the website via a predetermined website, is sent to the user, and the user's command is obtained from the website.

It is then determined whether the user has input a command to delete or to keep (step S805). When the user's command is to be deleted, it is determined to delete the website (step S803). When the command is not deleted, it is determined to keep the website (step S806).

While, in this embodiment, a command to delete or keep is requested from the user when there is a comment, or when the number of viewers exceeds the fixed number, the website may be kept automatically without a command from the user.

As described above, in the first embodiment, the deletion URL collection unit 140 collects information relating to the deletion website, the deletion URL disclosure unit 160 collects comments while disclosing the information for a fixed period, and the deletion determining unit 170 determines whether to delete the website based on the number of comment-writers and the number of viewers. When it has determined to delete, a request to delete the website is sent to the website disclosure server 30. This makes it possible to prevent unwanted websites from being left undeleted.

In the first embodiment, information relating to deletion websites is collected by posting deletion URL soliciting information on a members-only portal site. Alternatively, users who have entered into a predetermined contract may be prompted to consider deleting the website by sending them an e-mail requesting that they consider deleting the website, based on the states of viewing and updating of the website. Accordingly, there will next be described a second embodiment in which a web service server sends an e-mail that notifies users of a request to consider-deleting the website, based on the states of viewing and updating of the website.

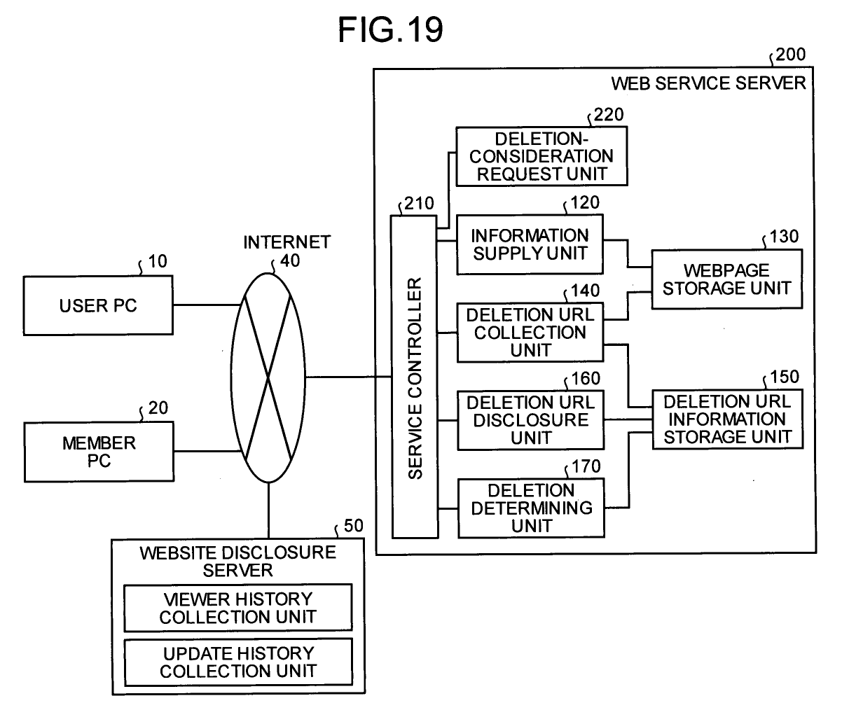

FIG. 19 is a functional block diagram of the system constitution of the web service system that provides the website-deleting service according to the second embodiment. For convenience of explanation, like parts to serve as functional units as those shown in FIG. 1 are designated with like reference signs and the explanations therefore will be omitted.

In the web service system according to the second embodiment, instead of the website disclosure server 30 of the web service system shown in FIG. 1, a website disclosure server 50 is connected to the Internet 40, and, instead of the web service server 100, a web service server 200 is connected to the Internet 40.

The website disclosure server 50 collects data relating to update histories of the website, in addition to view histories thereof. In addition to the functional units of the web service server 100 shown in FIG. 1, the web service server 200 also includes a deletion-consideration request unit 220, and has a service controller 210 instead of the service controller 110.

The deletion-consideration request unit 220 is a processor that sends-an e-mail to a user, notifying him/her of a deletion-consideration request, based on the states of viewing and updating of the website.

The deletion-consideration request unit 220 can prompt the user to delete the website by sending him/her an e-mail notifying him/her of a deletion-consideration request, based on the states of viewing and updating of the website. The service controller 210 is a processor that controls all the services supplied by the web service server 200.

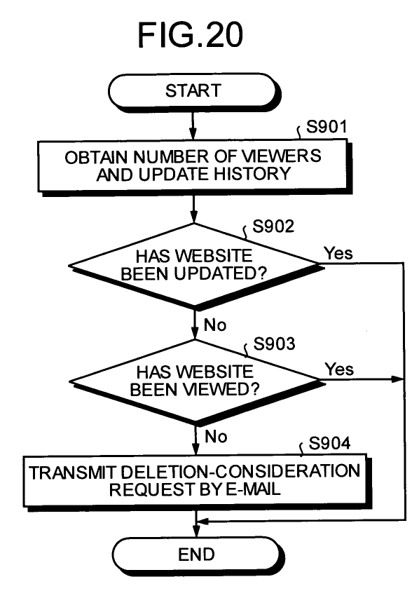

A processing sequence of the deletion-consideration request unit 220 will be explained. FIG. 20 is a flowchart of the processing sequence of the deletion-consideration request unit 220. The deletion-consideration request unit 220 is activated at fixed intervals.

As shown in FIG. 20, the deletion-consideration request unit 220 obtains a view history and an update history from the website disclosure server 50 (step S901), and determines whether the website has been updated during a predetermined time period (step S902).

When the website is not updated during the predetermined time period, the deletion-consideration request unit 220 determines whether the website is viewed during the predetermined time period (step S903), and if not, sends the deletion-consideration request to the user by an e-mail (step S904). When the website is viewed or updated during the predetermined time period, processing is terminated without sending the deletion-consideration request to the user.

As described above in the second embodiment, the deletion-consideration request unit 220 sends an e-mail to a user, notifying him/her of a deletion-consideration request, based on the state of viewing and updating of the website, thereby prompting him/her to delete the website. While, in the second embodiment, the creator of the website is notified of the deletion-consideration request, it may instead be sent to the manager who holds the rights for the website.

While, in the second embodiment, the user is notified of the deletion-consideration request by an e-mail, a website that has not been viewed or updated for a predetermined period of time may be automatically posted on the members-only portal site as a deletion website, by entering into a predetermined contract with the user.

While, in the first and the second embodiments, members of a members-only organization write comments regarding a deletion website, the present invention is not limited to this, and may be similarly applied when, for example, users write comments regarding deletion websites of other users, or comments are collected from arbitrary Internet users other than members. Deletion websites can also be solicited and disclosed on sites other than the members-only portal site.

While FIGS. 1 and 19 explain the functional constitutions of web service servers, the functional units that relate to website deletion processing, such as the deletion URL collection unit 140, the deletion URL information storage unit 150, the deletion URL disclosure unit 160, and the deletion determining unit 170, can be collectively obtained by using a website-deleting apparatus.

The functional units that relate to website deletion processing, such as the deletion URL collection unit 140, the deletion URL information storage unit 150, the deletion URL disclosure unit 160, and the deletion determining unit 170, can also be collectively obtained by using a website deletion program. Accordingly, a computer system that executes the website deletion program will be explained.

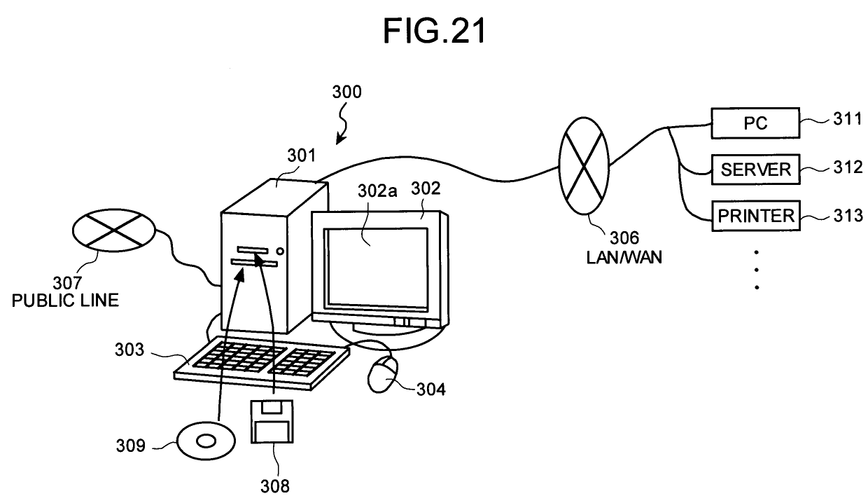

FIG. 21 is a diagram of a computer system that executes a computer program according to the first and the second embodiments. As shown in FIG. 21, the computer system 300 includes a main unit 301, a display 302 that displays information on a display screen 302a in compliance with a command from the main unit 301, a keyboard 303 for inputting a variety of information to the computer system 300, a mouse 304 that specifies a given position on the display screen 302a of the display 302, a local are network (LAN) interface that connects to a LAN 306 and a wide area network (WAN), and a modem that connects to a public line 307. The LAN 306 connects the computer system 300 to another computer system (PC) 311, a server 312, a printer 313, and the like.

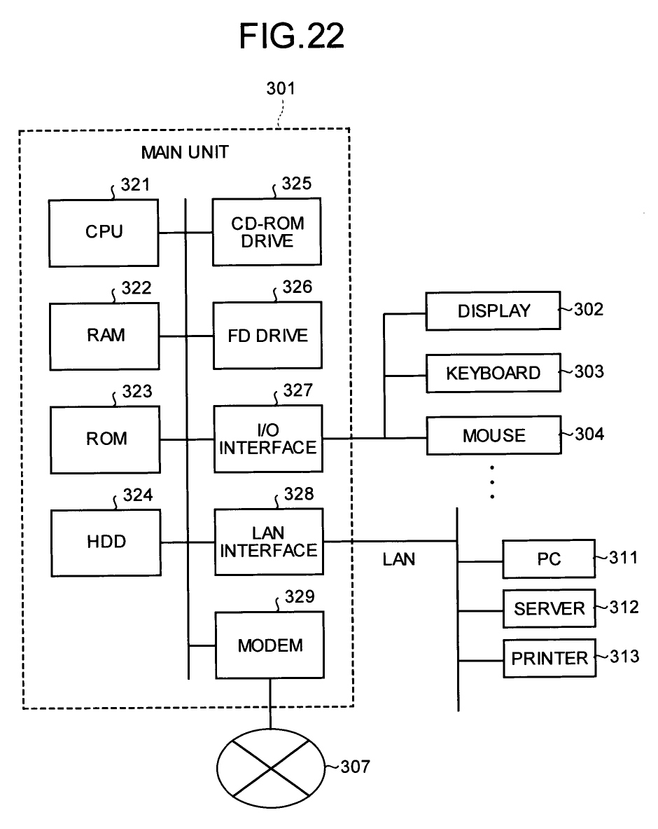

FIG. 22 is a functional block diagram of the constitution of the main unit 301 of FIG. 21. As shown in FIG. 22, the main unit 301 includes a central processing unit (CPU) 321, a random access memory (RAM) 322, a read only memory (ROM) 323, a hard disk drive (HDD) 324, a CD-ROM drive 325, a floppy disk (FD) drive 326, an I/O interface 327, a LAN interface 328, and a modem 329.

The computer program executed by the computer system 300 is stored in a portable recording medium, such as a FD 308, a CD-ROM 309, a digital versatile disk (DVD), a magneto-optical disk, an integrated circuit (IC) card, or the like, and is installed in the computer system 300 by reading it from the recording medium.

Alternatively, the computer program may be stored in the database of the server 312, which is connected via the LAN interface 328, or in the database of the PC 311, or the like, and installed in the computer system 300 by reading it from these databases.

When the computer program is installed, it is stored in the HDD 324, and executed by the CPU 321 by using the RAM 322, the ROM 323, and the like.

According to the present invention, since the websites can be deleted automatically, proprietors of the websites can easily delete their unwanted websites. If the unwanted websites are deleted, disk space can be used effectively.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A document data managing apparatus comprising:
a deletion information receiving unit that receives deletion document data information, being information relating to document data to be deleted, from document data managers;
a deletion information disclosing unit that discloses the deletion document data information received and collects evaluation information relating to the document data; and
a deletion determining unit that determines whether to delete the document data based on the evaluation information collected, and, when determined to delete, deletes the document data.

2. The document data managing apparatus according to claim 1, further comprising a deletion-consideration request notifying unit that notifies the document data manager of a request to consider deleting the document data.

3. The document data managing apparatus according to claim 1, wherein the deletion information receiving unit comprises:
a soliciting unit that solicits document data to be deleted; and
a document data information collecting unit that receives deletion document data information from document data managers who applied to the soliciting unit.

4. The document data managing apparatus according to claim 1, wherein the deletion information disclosing unit comprises:
a document data information disclosing unit that discloses deletion document data information; and
an evaluation information collecting unit that collects evaluation information relating to the deletion document data information disclosed by the document data information disclosing unit.

5. The document data managing apparatus according to claim 1, wherein the deletion information disclosing unit collects comments regarding the document data as part of the evaluation information, and
the deletion determining unit determines whether to delete the document data based on the comments collected.

6. The document data managing apparatus according to claim 5, wherein the deletion determining unit determines whether to delete the document data based on the number of viewers of the document data, in addition to the comments.

7. The document data managing apparatus according to claim 6, wherein the deletion determining unit determines to delete document data that has no comments and the number of viewers that is below a predetermined number.

8. The document data managing apparatus according to claim 1, wherein the document data constitutes a website, and the document data manager is a creator of the website.

9. A document data management method comprising:
receiving deletion document data information, being information relating to document data to be deleted, from document data managers;
disclosing the deletion document data information received at the receiving;
collecting evaluation information relating to the deletion document data information disclosed at the disclosing;
determining whether to delete the document data based on the evaluation information collected at the collecting; and
deleting the document data when it is determined at the determining to delete the deletion data.

10. The document data management method according to claim 9, further comprising notifying the document data manager of a request to consider deleting the document data.

11. The document data management method according to claim 9, wherein the receiving includes:
soliciting document data to be deleted; and
receiving deletion document data information from document data managers who applied to a solicitation at the soliciting.

12. The document data management method according to claim 9, wherein the disclosing includes:
disclosing deletion document data information; and
collecting evaluation information relating to the deletion document data information disclosed at the disclosing.

13. The document data management method according to claim 9, wherein the disclosing includes collecting comments regarding the deletion document data information as part of the evaluation information, and
the determining includes determining whether to delete the document data based on the comments collected at the collecting comments.

14. The document data management method according to claim 13, wherein the determining includes determining whether to delete the document data based on the number of viewers of the document data, in addition to the comments.

15. The document data management method according to claim 14, wherein the determining includes determining to delete document data that has no comments and for which number of viewers is below a predetermined number.

16. The document data management method according to claim 9, wherein the document data is a website, and the document data manager is a creator of the website.

17. A computer-readable recording medium that stores therein a computer program that causes a computer to execute:
receiving deletion document data information, being information relating to document data to be deleted, from document data managers;
disclosing the deletion document data information received at the receiving;
collecting evaluation information relating to the deletion document data information disclosed at the disclosing;
determining whether to delete the document data based on the evaluation information collected at the collecting; and
deleting the document data when it is determined at the determining to delete the deletion data.

18. The computer-readable recording medium according to claim 17, which further makes a computer execute notifying the document data manager of a request to consider deleting the document data.

19. The computer-readable recording medium according to claim 17, wherein the receiving includes:
soliciting document data to be deleted; and
receiving deletion document data information from document data managers who applied to a solicitation at the soliciting.

20. The computer-readable recording medium according to claim 17, wherein the disclosing includes:
disclosing deletion document data information; and
collecting evaluation information relating to the deletion document data information disclosed at the disclosing.

21. The computer-readable recording medium according to claim 17, wherein the disclosing includes collecting comments regarding the deletion document data information as part of the evaluation information, and
the determining includes determining whether to delete the document data based on the comments collected at the collecting comments.

22. The computer-readable recording medium according to claim 21, wherein the determining includes determining whether to delete the document data based on the number of viewers of the document data, in addition to the comments.

23. The computer-readable recording medium according to claim 22, wherein the determining includes determining to delete document data that has no comments and for which number of viewers is below a predetermined number.

24. The computer-readable recording medium according to claim 17, wherein the document data is a website, and the document data manager is a creator of the website.
